(19) United States
(12) Patent Application Publication
(10) Pub. No.: US 2019/0225266 A1
(43) Pub. Date: Jul. 25, 2019

(54) OBJECT DETECTION DEVICE AND VEHICLE CONTROL SYSTEM COMPRISING OBJECT DETECTION DEVICE

(71) Applicant: HITACHI AUTOMOTIVE SYSTEMS, LTD., Hitachinaka-shi, Ibaraki (JP)

(72) Inventors: Yoshiaki ENOMOTO, Hitachinaka-shi, Ibaraki (JP); Yuta MUTO, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/313,084

(22) PCT Filed: Jul. 20, 2017
(86) PCT No.: PCT/JP2017/026235

§ 371 Date: Dec. 24, 2018

(30) Foreign Application Priority Data
Aug. 8, 2016 (JP) 2016-155811

(51) Int. Cl. B62D 15/02; G06T 7/70; G06T 7/13; G06T 7/60

(52) U.S. Cl. CPC B62D 15/0255; G06T 7/70; G01S 13/931; G06T 7/60; G06T 7/13

(57) ABSTRACT

The present invention provides: an object detection device that can appropriately specify, or estimate, the presence region (the vehicle length or the like) of an object, such as another vehicle, that is in the periphery of a vehicle; and a vehicle control system that comprises the object detection device. The present invention comprises: an external environment information acquisition unit 2 that acquires external environment information for different detection regions in the surroundings of a vehicle; and an object presence region setting unit 3 that associates detection results from the external environment information acquisition unit 2 for the different detection regions and specifies, or estimates, object presence regions in which an object is present or in which an object may be present in the surroundings of the vehicle.

### TECHNICAL FIELD

The present invention relates to an object detection device and a vehicle control system including the object detection device and, for example, to an object detection device that monitors the periphery of a vehicle and calculates a vehicle length of another vehicle detected in the surroundings of the vehicle; and a vehicle control system including the object detection device.

### BACKGROUND ART

In automatic driving/driving support system, when a merging vehicle (for example, another vehicle traveling on a merging lane while the vehicle is traveling on a main line and another vehicle traveling on a main line while the vehicle is traveling on a merging lane) is observed at a merging section, smooth merging is supported while the inter-vehicle distance between the vehicle and a preceding vehicle is controlled.

Incidentally, in the automatic driving/driving support system, when the vehicle and a merging vehicle are traveling side by side and the total length of the merging vehicle is unknown, there is a risk of danger at the time of merging without merging support (while no actions for merging are taken). Therefore, it is necessary to appropriately find out the total length of another vehicle in the periphery of the vehicle.

As a conventional technology for finding out an object present in the periphery of the vehicle, for example, an on-vehicle radar device disclosed in following PTL 1 is known. In this conventional on-vehicle radar device disclosed in PTL 1, the position of an object in the periphery of the vehicle is measured using a radar and the size of another vehicle is found out using a camera that photographs the periphery of the vehicle. Then, in this technology, a grouped region for each position measured for single another vehicle and a grouped region having measurements designated according to the size of the another vehicle are grouped into a group for each equal position, whereby the accuracy of finding out another vehicle in the periphery of the vehicle is improved.

### CITATION LIST

### Patent Literature

PTL 1: JP 2007-212418 A

### SUMMARY OF INVENTION

### Technical Problem

However, even for another vehicle located in a detection region in the periphery of the vehicle, a case where the entire vehicle can be detected within the detection region of a single sensor and a case where another vehicle can be detected by crossing the detection regions of a plurality of sensors are conceivable. In the conventional on-vehicle radar device disclosed in above-mentioned PTL 1, the same detection region is detected by a plurality of sensors (in this technology, detected by the radar and the camera) and the size such as the vehicle length of another vehicle located in this detection region is found out by a single sensor (camera). Accordingly, consideration is not given to another vehicle in the periphery that is detected across the detection regions of a plurality of sensors. For this reason, it is impossible to appropriately find out the vehicle length or the like of another vehicle that is present across the detection regions of the plurality of sensors.

In addition, in the periphery of the vehicle, there is a non-detection region (a region where an object cannot be detected by a sensor or the like mounted on the vehicle) other than the detection region and it is also conceivable that a part or whole of another vehicle in the periphery of the vehicle is located in this non-detection region. In the conventional technology disclosed in above-mentioned PTL 1, however, it is not possible to find out the vehicle length or the like of another vehicle present within such a non-detection region.

The present invention has been made in view of the above problems and it is an object of the present invention to provide an object detection device that can appropriately specify, or estimate, the presence region (the vehicle length or the like) of an object, such as another vehicle, that is present in the periphery of a vehicle; and a vehicle control system that includes the object detection device.

### Solution to Problem

In order solve the above problems, an object detection device according to the present invention includes: an external environment information acquisition unit that acquires external environment information for different detection regions in the surroundings of a vehicle; and an object presence region setting unit that associates detection results from the external environment information acquisition unit for the different detection regions and specifies, or estimates, object presence regions in which an object is present or in which an object may be present in the surroundings of the vehicle.

In addition, a vehicle control system according to the present invention includes the object detection device and a travel control device that controls a traveling state of the vehicle on the basis of the object presence region specified or estimated by the object detection device.

### Advantageous Effects of Invention

According to the present invention, by associating detection results for different detection regions in the surroundings of the vehicle, it is possible to appropriately specify or estimate the object presence region in which an object such as another vehicle in the periphery of the vehicle is present. In addition, by controlling the traveling state based on the object presence region (for example, vehicle length information on another vehicle) specified or estimated by the object detection device, for example, determination on vehicle interrupting (being interrupted) at the time of merging during operation of the automatic driving/driving support system can be accurately judged.

Problems, configurations, and effects other than those mentioned above will be clarified by the description of the following embodiments.

### BRIEF DESCRIPTION OF DRAWINGS

FIG. 1 is a block configuration diagram of a first embodiment of an object detection device according to the present invention.

FIG. 2 is a plan view illustrating an example of a situation of detecting a target vehicle crossing a plurality of detection regions.

FIG. 3 is an example of a detected matter integrated mapping diagram created by a detected matter integrated mapping unit of a physical value computation unit illustrated in FIG. 1.

FIG. 4 is an example of a recognized vehicle mapping diagram created by a recognized vehicle mapping unit of a vehicle length computation unit illustrated in FIG. 1.

FIG. 5 is a flowchart illustrating a processing flow by the object detection device illustrated in FIG. 1.

FIG. 6 is a plan view illustrating another example of a situation of detecting a target vehicle sandwiching a plurality of detection regions.

FIG. 7 is an example of a detected matter integrated mapping diagram created by a detected matter integrated mapping unit of a physical value computation unit in a second embodiment of the object detection device according to the present invention.

FIG. 8 is a flowchart illustrating a processing flow of an entire vehicle recognition process by the second embodiment of the object detection device according to the present invention.

FIG. 9 is a plan view illustrating an example of an object presence possibility region in the periphery of a vehicle.

FIG. 10 is a conceptual diagram illustrating a processing pattern (part 1) when a target vehicle is detected with a non-detection region sandwiched.

FIG. 11 is a conceptual diagram illustrating a processing pattern (part 2) when target vehicles are detected with a non-detection region sandwiched.

FIG. 12 is a conceptual diagram illustrating a processing pattern (part 3) when a target vehicle is detected with a non-detection region sandwiched.

FIG. 13 is a conceptual diagram illustrating a processing pattern (part 4) when a target vehicle is detected with a non-detection region sandwiched.

FIG. 14 is a conceptual diagram illustrating a processing pattern (part 5) when a target vehicle is detected with a non-detection region sandwiched.

FIG. 15 is a conceptual diagram illustrating a processing pattern (part 6) when a target vehicle is detected with a non-detection region sandwiched.

FIG. 16 is bird's eye views illustrating situations of travel control by a vehicle control system according to the present invention, where (A) is a diagram illustrating a situation in which another vehicle is merging from the rear side of a vehicle and (B) is a diagram illustrating a situation in which another vehicle is merging from the front side of a vehicle.

FIG. 17 is a flowchart illustrating a processing flow of travel control by the vehicle control system according to the present invention.

### DESCRIPTION OF EMBODIMENTS

Hereinafter, embodiments according to the invention will be described with reference to the drawings.

### First Embodiment of Object Detection Device

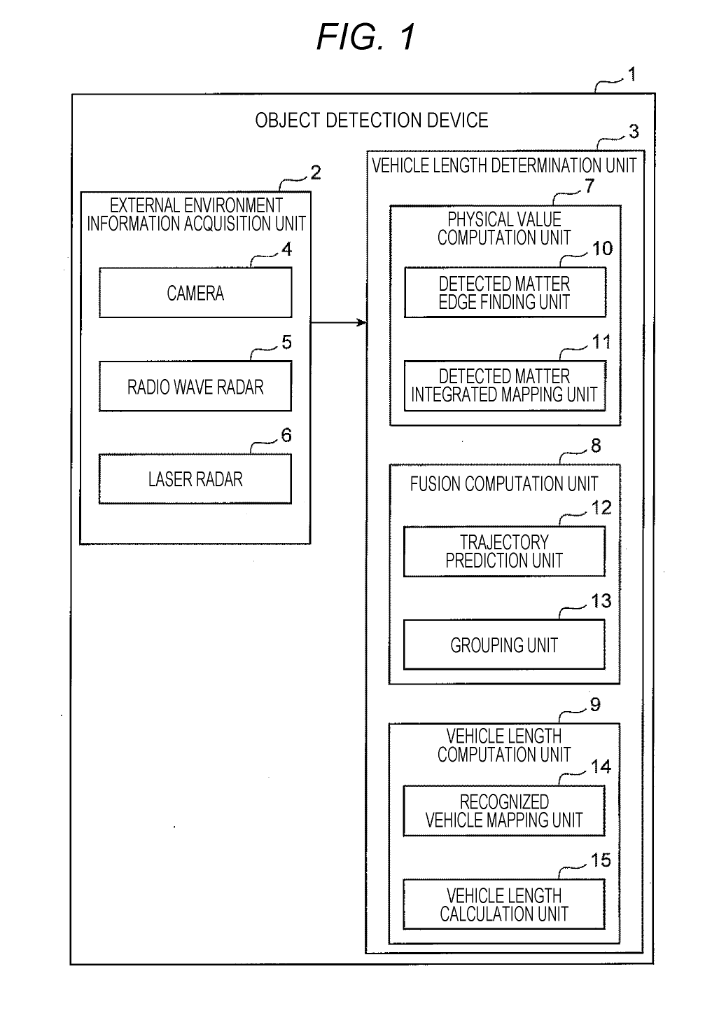

First, a first embodiment of an object detection device according to the present invention will be described with reference to FIGS. 1 to 5.

FIG. 1 illustrates a block configuration diagram of an object detection device according to the embodiment of the present invention.

The object detection device of the present embodiment is mounted on a vehicle that travels on a road and is used for accurately specifying or estimating a presence region (object presence region) for an object such as a detected vehicle (another vehicle) in the periphery of the vehicle.

Note that, in the following explanation, a case where the object detection device according to the present embodiment calculates the vehicle length of a detected vehicle (another vehicle) in the periphery of a vehicle will be particularly described as an example. However, in addition to specifying or estimating the object presence region mentioned above, the object detection device may also calculate, for example, the vehicle width or an arbitrary point (end point or the like) of the detected vehicle (another vehicle) from the specified or estimated object presence region.

As illustrated in FIG. 1, the object detection device is constituted mainly by an external environment information acquisition unit 2 and a vehicle length determination unit (object presence region setting unit) 3 included therein.

The external environment information acquisition unit is used for acquiring external environment information for different detection regions in the surroundings of the vehicle and constituted by a camera 4, a radio wave radar 5, a laser radar 6, and the like.

A stereo camera, a monocular camera, or a charge-coupled device (CCD) camera is used as the camera 4 and is equipped, for example, in the front of the vehicle, in the rear of the vehicle, and on the sides of the vehicle to image each predetermined range and find out image marker information.

The radio wave radar 5 is equipped, for example, on the left and right front and rear sides of the vehicle and transmits radio waves to predetermined ranges on the front and rear sides of the vehicle to receive reflected waves from objects on the front and rear sides, thereby finding out the relative position (distance, direction, and size in a horizontal direction) and the relative speed with respect to these objects on the front and rear sides (these pieces of information are referred to as radar marker information).

The laser radar 6 is equipped, for example, in the left and right front and rear of the vehicle and transmits laser light to predetermined ranges in the periphery of the vehicle to receive reflected light from objects in the periphery of the vehicle, thereby finding out the relative position (distance, direction, and size) and the relative speed with respect to these objects in the periphery of the vehicle (these pieces of information are referred to as radar marker information). In addition, since the laser radar 6 uses an electromagnetic wave having a wavelength much shorter than that of the radio wave radar 5, the laser radar 6 is characterized in having a higher three-dimensional size detection accuracy for a detected object but having a shorter detection distance. Therefore, it is possible to adopt a configuration in which the laser radar is used together with the radio wave radar 5 as a complementary role of the radio wave radar 5, or a configuration in which the radio wave radar 5 is replaced with the laser radar 6.

Meanwhile, the vehicle length determination unit (object presence region setting unit) 3 is used for specifying or estimating an object presence region in which an object (another vehicle or a detected vehicle) is present or an object (another vehicle or a detected vehicle) may be present in the surroundings of the vehicle to calculate the length (vehicle length) of this object (another vehicle or a detected vehicle) in a front-rear direction. The vehicle length determination unit (object presence region setting unit) 3 is constituted mainly by a physical value computation unit 7, a fusion computation unit 8, and a vehicle length computation unit 9.

Based on the image marker information by the camera 4 acquired by the external environment information acquisition unit 2, the physical value computation unit 7 works out the distance and direction with respect to the detected vehicle and the edge (end portion) of the detected vehicle, using a detected matter edge finding unit 10. The edge (end portion) of the detected vehicle is also worked out based on the radar marker information by the radio wave radar 5 or the like. In addition, based on the information acquired by the external environment information acquisition unit 2 and the edge (end portion) of the detected vehicle worked out by the detected matter edge finding unit 10, the physical value computation unit 7 maps the detected vehicle on coordinates centered on the vehicle, using a detected matter integrated mapping unit 11.

Based on the information obtained by the physical value computation unit 7, the fusion computation unit 8 predicts the trajectory of a vehicle detected for each detection region of the external environment information acquisition unit 2, using a trajectory prediction unit 12 and also determines whether the vehicle detected for each detection region is the same vehicle, using a grouping unit 13.

With respect to a vehicle regarded as the same vehicle by the fusion computation unit 8, the vehicle length computation unit 9 maps the same vehicle on the coordinates centered on the vehicle (that is, specifies an object presence region in which the detected vehicle is present on the coordinates centered on the vehicle), using a recognized vehicle mapping unit 14 and computes the dimensions (vehicle length) between the front and rear edges (end portions) of this same vehicle based on the mapping coordinates, using a vehicle length calculation unit 15.

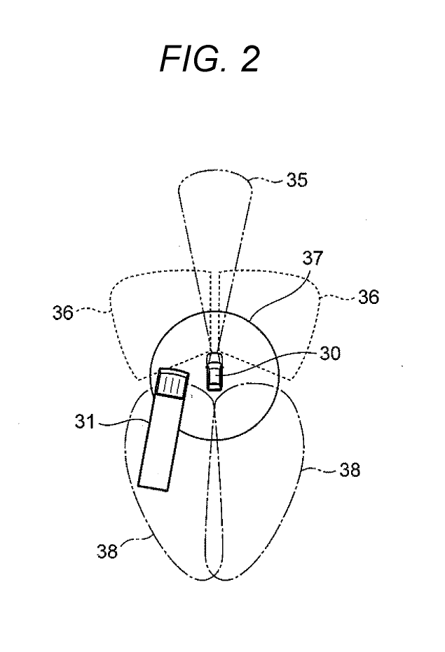

FIG. 2 illustrates a situation in which the external environment information acquisition unit 2 of the object detection device 1 detects another vehicle in the periphery and particularly illustrates a situation in which a target vehicle (detected vehicle) crossing a plurality of detection regions is detected.

In this example, it is assumed that a vehicle 30 is mounted with the camera 4 and the radio wave radar 5. The camera 4 is attached to the front of the vehicle and a region 35 in front of the vehicle is settled as a detection region of the camera 4. In addition, wide angle cameras 4 are attached to the front, rear, left, and right of the vehicle 30 and a region 37 for detecting around 360 degrees of the periphery of the vehicle (a predetermined range thereof) is settled as a detection region of these wide angle cameras 4. Likewise, the radio wave radar 5 is attached to each of the front, rear, left, and right end portions of the vehicle 30 and regions 36 for detecting in a front side area and regions 38 for detecting in a rear side area are settled as detection regions of these radio wave radars 5. For example, when a target vehicle 31 is present on the left side, the entire target vehicle 31 is detected in the detection region 37 of the wide angle cameras 4 and the detection region 38 of the radio wave radar 5 on the left rear side.

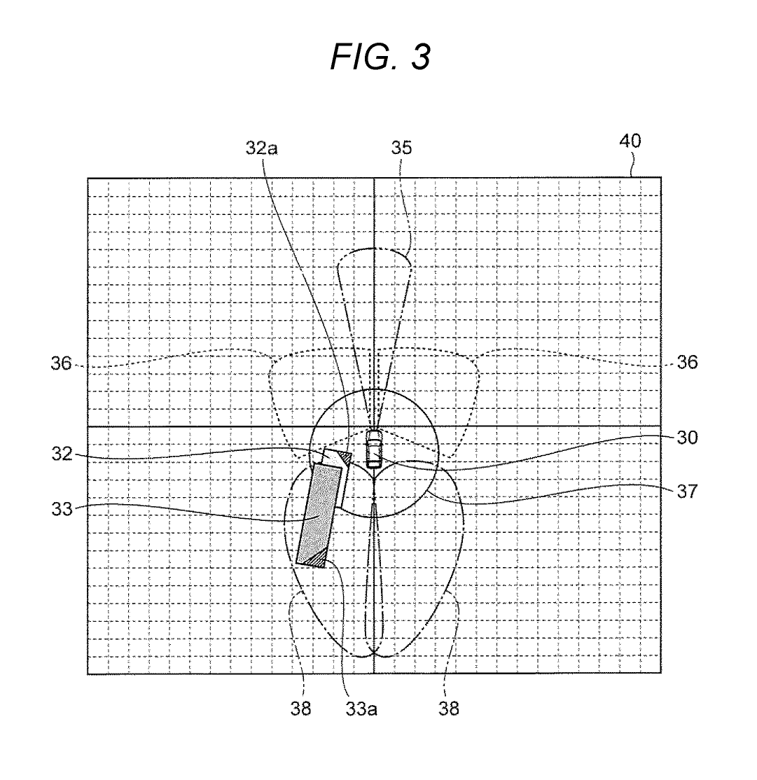

FIG. 3 illustrates an example (detected matter integrated mapping diagram 40) in which pieces of information individually detected in a plurality of detection regions (in this example, the detection region 37 of the wide angle cameras 4 and the detection region 38 of the radio wave radar 5) for the target vehicle 31 in line with the example in FIG. 2 are mapped on the coordinates centered on the vehicle 30 by the detected matter integrated mapping unit 11 of the physical value computation unit 7. This example here is expressed by two-dimensional coordinates in longitudinal and lateral directions with a front center portion of the vehicle 30 as the center point. Information detected in the detection region 37 of the wide angle cameras 4 (in other words, an object presence region of the target vehicle 31 in the detection region 37) is indicated as a detected target vehicle 32, whereas information detected in the detection region 38 of the radio wave radar 5 on the left rear side (in other words, an object presence region of the target vehicle 31 in the detection region 38) is indicated as a detected target vehicle 33. In addition, as information on the detected target vehicles 32 and 33 in the detection regions 37 and 38, edge portions (end points) are indicated as 32a and 33a, respectively. Generally, at this stage, a deviation occurs between the detected target vehicles 32 and 33.

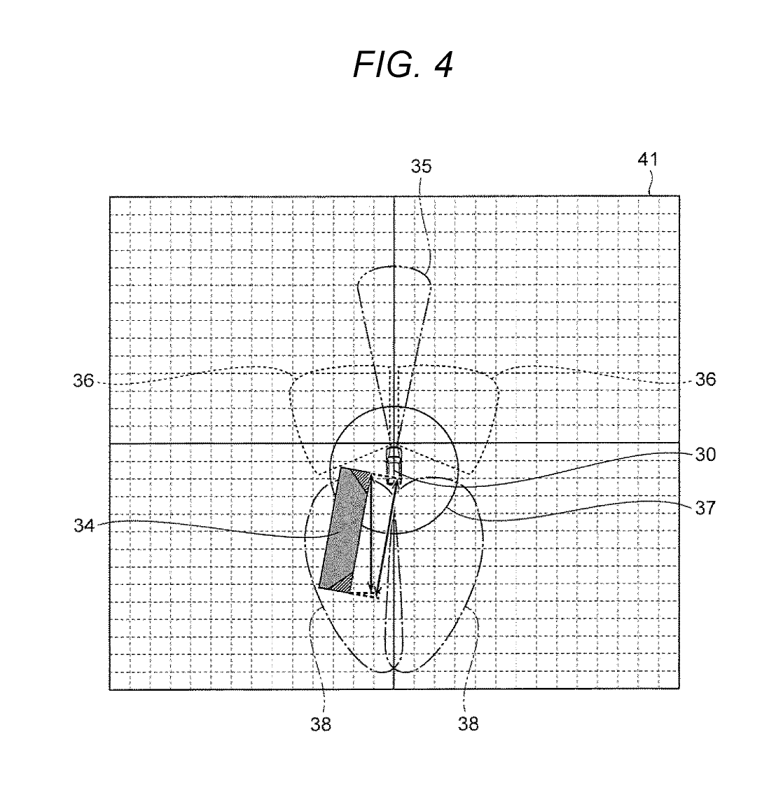

FIG. 4 illustrates an example (recognized vehicle mapping diagram 41) in which the recognized vehicle mapping unit 14 of the vehicle length computation unit 9 maps, on the coordinates centered on the vehicle 30, a target vehicle (=object presence region) 34 obtained by grouping the target vehicle detected across the plurality of detection regions illustrated in FIG. 3 as the same vehicle estimated by the fusion computation unit 8, by trajectory prediction according to each detection region. This target vehicle 34 has information on the edge portions (end points) at the front and rear of the vehicle, such that the vehicle length calculation unit 15 of the vehicle length computation unit 9 can calculate the vehicle length of the target vehicle 34 (the length of the target vehicle in the front-rear direction or the length of the target vehicle in a direction parallel to the front-rear direction of the vehicle) by computing a distance between coordinates of the respective edge portions (end points) on the coordinates of the recognized vehicle mapping diagram 41.

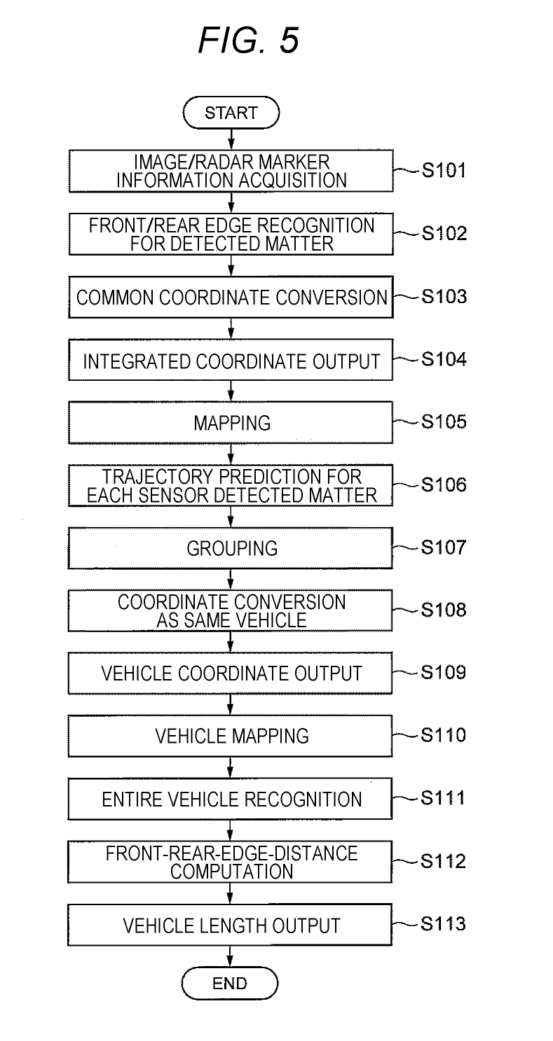

FIG. 5 illustrates a processing flow of a series of these processes (processes by the object detection device 1).

In an image/radar marker information acquisition process S101, detection information (image/radar marker information) for different detection regions in the surroundings of the vehicle is obtained from a plurality of sensors (the camera 4, the radio wave radar 5, and the like) of the external environment information acquisition unit 2. This image/radar marker information includes measurements, a distance, a relative speed, a bearing, a boundary line, a radio wave strength, and the like of a detected matter in each detection region.

In a front/rear edge recognition process S102 for the detected matter, the edge portion (end point) of the detected matter in each detection region is recognized based on the image/radar marker information acquired in the image/radar marker information acquisition process S101. For example, for the camera 4, the edge portion of the detected vehicle is recognized by combinations of longitudinal edges and pattern matching of the vehicle based on the captured images. In addition, for the radio wave radar 5, a transmission beam width is narrowed for the detected matter when an object is detected within the detection region and the edge portion is recognized by the radio wave reflection intensity for the detected vehicle (detected matter).

In a common coordinate conversion process S103, range and azimuth (angle) information from the image/radar marker information acquired in the image/radar marker information acquisition process S101 and the position of the edge portion recognized in the front/rear edge recognition process S102 for the detected matter are converted into longitudinal and lateral two-dimensional coordinates with the vehicle as the center point. In an integrated coordinate output process S104, the longitudinal and lateral two-dimensional coordinates converted in the common coordinate conversion process S103 are collectively output as integrated coordinates.

In a mapping process S105, the detection information from each detection region converted in the common coordinate conversion process S103 and collected as integrated coordinates in the integrated coordinate output process S104 is mapped (refer to the detected matter integrated mapping diagram in FIG. 3).

In a trajectory prediction process S106 for each sensor detected matter, the trajectory of the detected matter in each detection region by the mapping process S105 is estimated based on the history of the accumulated previous image/radar marker information.

In a grouping process S107, using the detection information from each detection region collected as integrated coordinates in the integrated coordinate output process S104 and information for the detected matter trajectory in each detection region estimated in the trajectory prediction process S106 for each sensor detected matter, clustering and grouping are performed to make estimation as the same vehicle.

In a coordinate conversion process S108 as the same vehicle, information obtained by estimating markers (detected matters) that have been separately detected in a plurality of detection regions as the same vehicle in the grouping process S107 is converted into longitudinal and lateral two-dimensional coordinates with the vehicle as the center point. In a vehicle coordinate output process S109, the longitudinal and lateral two-dimensional coordinates converted in the coordinate conversion process S108 as the same vehicle are output as vehicle coordinates.

In a vehicle mapping process S110, the vehicle coordinates converted in the coordinate conversion process S108 as the same vehicle and output in the vehicle coordinate output process S109 are mapped (refer to the recognized vehicle mapping diagram in FIG. 4).

In an entire vehicle recognition process S111, if a vehicle mapped to the vehicle coordinates in the vehicle mapping process S110 is a continuous marker including the information on the front and rear edge portions (end points), it is assumed that the entire vehicle is recognized.

In a front-rear-edge-distance computation process S112, a distance between coordinates of the front and rear edge portions (end points) is computed with the coordinates by the vehicle mapping process S110 for the target vehicle, for which the entire vehicle has been recognized in the entire vehicle recognition process S111. In a vehicle length output process S113, a calculation result of the front-rear-edge-distance computation process S112 is output as the vehicle length of the target vehicle.

Note that the above embodiment has described the case of calculating the vehicle length of another vehicle (detected vehicle) detected across different detection regions. However, of course it is also possible to similarly calculate the vehicle length of a detected vehicle accommodated within a single detection region when detected.

By repeating a series of these processes, the vehicle length can be calculated for a detected vehicle detected in the periphery of the vehicle.

As described thus far, according to the object detection device 1 of the present first embodiment, by associating detection results from the external environment information acquisition unit 2 for different detection regions in the surroundings of the vehicle, it is possible to appropriately specify an object presence region in which an object such as another vehicle detected in the periphery of the vehicle is present and appropriately calculate the vehicle length and the like of the another vehicle.

### Second Embodiment of Object Detection Device

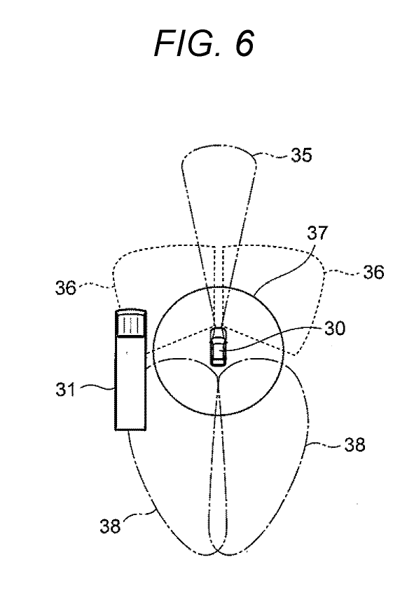

Next, a second embodiment of the object detection device according to the present invention will be described with reference to FIGS. 6 to 15.

The present second embodiment is different from the first embodiment described above in the configuration pertinent to the vehicle length determination unit 3 in the block configuration diagram of the object detection device 1 in FIG. 1, in detail, the configuration pertinent to the entire vehicle recognition process S111 in the processing flow of the object detection device 1 in FIG. 5, and the other configurations are approximately the same as those of the first embodiment described above. Therefore, the same reference numerals are given to the same configurations as those of the first embodiment described above and the detailed description thereof will be omitted. Only the differences will be described in detail below.

In the first embodiment described above, in the entire vehicle recognition process S111 in the processing flow in FIG. 5, it is assumed that the entire vehicle is recognized if a mapped marker is a continuous marker including the information on the front and rear edge portions (end points); then, a distance between coordinates of the front and rear edge portions (end points) is computed in the front-rear-edge-distance computation process S112 and a calculation result thereof is output as the vehicle length in the vehicle length output process S113.

In the present second embodiment, it is supposed that, in the above-described entire vehicle recognition process S111, an object presence region in which an object such as another vehicle is present or an object may be present in the surroundings of the vehicle is specified or estimated and the vehicle length of the another vehicle is estimated and calculated mainly in the following cases.

(1) A case where the information on the front and rear edge portions (end points) is included and there is an undetected section between the front and rear edge portions (end points) of a discontinuous marker, that is, the detected target vehicle.

(2) A case where, with regard to a marker having information on only one of the front and rear edge portions (end points), the other edge portion (end point) of the detected target vehicle is present in an area (non-detection region) between multiple detection regions of a plurality of sensors (a camera 4, a radio wave radar 5, and the like) constituted in an external environment information acquisition unit 2.

(3) A case where the target vehicle is not present (not detected) in any detection region by a plurality of sensors (the camera 4, the radio wave radar 5, and the like) constituted in the external environment information acquisition unit 2. In other words, a case where the target vehicle is present in a non-detection region between multiple detection regions, or the target vehicle is not present in any detection region or non-detection region.

Note that the block configuration of the object detection device 1 of the present second embodiment is the same as the block configuration of the object detection device 1 of the first embodiment described with reference to FIG. 1.

FIG. 6 illustrates a situation in which the external environment information acquisition unit 2 of the object detection device 1 detects another vehicle and particularly illustrates a situation in which a target vehicle (detected vehicle) crossing a plurality of detection regions with a non-detection region sandwiched therebetween is detected.

As described earlier, the configuration of the external environment information acquisition unit 2 constituting the object detection device 1 is the same as that of the first embodiment, in which, with the vehicle 30 as the center, the camera 4 is attached to the front of a vehicle 30, a region 35 in front of the vehicle is settled as a detection region of this camera 4, wide angle cameras 4 are attached to the front, rear, left, and right of the vehicle 30, and a region 37 for detecting around 360 degrees of the periphery of the vehicle (a predetermined range thereof) is settled as a detection region of these wide angle cameras 4. Likewise, the radio wave radar 5 is attached to each of the front, rear, left, and right end portions of the vehicle 30 and regions 36 for detecting in a front side area and regions 38 for detecting in a rear side area are settled as detection regions of these radio wave radars 5. For example, when a target vehicle 31 is present on the left side, a front portion of the target vehicle 31 is detected in the detection region 36 of the radio wave radar 5 on the left front side and a rear portion of the target vehicle 31 is detected in the detection region 38 of the radio wave radar 5 on the left rear side. In this example, the target vehicle 31 is located outside the detection region of the detection region 37 of the wide angle cameras 4 (on the outside of the detection region 37 of the wide angle cameras 4) and an intermediate portion (a portion between the front portion and the rear portion) of the target vehicle 31 is present between the detection region 36 and the detection region 38 of the radio wave radars 5 on the front and rear sides on the outside of the detection region 37 of the wide angle cameras 4. Accordingly, a part (the front portion and the rear portion) of the target vehicle sandwiching the plurality of detection regions is detected and a part (intermediate portion) thereof is not detected.

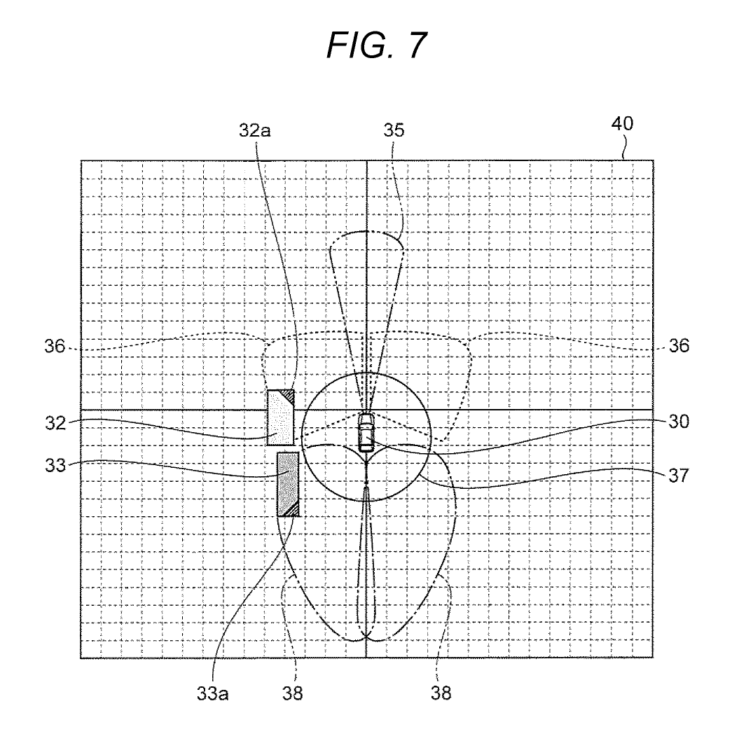

FIG. 7 illustrates an example (detected matter integrated mapping diagram 40) in which pieces of information individually detected in a plurality of detection regions (in this example, the detection region 36 and the detection region 38 of the radio wave radars 5) for the target vehicle 31 in line with the example in FIG. 6 are mapped on coordinates centered on the vehicle 30 by a detected matter integrated mapping unit 11 of a physical value computation unit 7 of a vehicle length determination unit 3. As in the case of FIG. 3 of the first embodiment described above, this example is expressed by two-dimensional coordinates in longitudinal and lateral directions with a front center portion of the vehicle 30 as the center point. Information detected in the detection region 36 of the radio wave radar 5 on the left front side (in other words, a rectangular object presence region of the target vehicle 31 relating to the detection region 36) is indicated as a detected target vehicle 32, whereas information detected in the detection region 38 of the radio wave radar 5 on the left rear side (in other words, a rectangular object presence region of the target vehicle 31 relating to the detection region 38) is indicated as a detected target vehicle 33. In addition, as information on the detected target vehicles 32 and 33 in the detection regions 36 and 38, edge portions (end points) are indicated as 32a and 33a, respectively.

Note that, in this case, even if the trajectory prediction and the grouping according to each detection region are performed by a fusion computation unit 8 (a trajectory prediction unit 12 and a grouping unit 13 thereof), there is a high possibility that a deviation has occurred between the detected target vehicles 32 and 33 mapped by a recognized vehicle mapping unit 14 of a vehicle length computation unit 9.

As described above, in the examples illustrated in FIGS. 6 and 7, only the front portion and the rear portion of the target vehicle 31 are detected with the non-detection region sandwiched, as the detected target vehicle 32 and the detected target vehicle 33 that have been mapped.

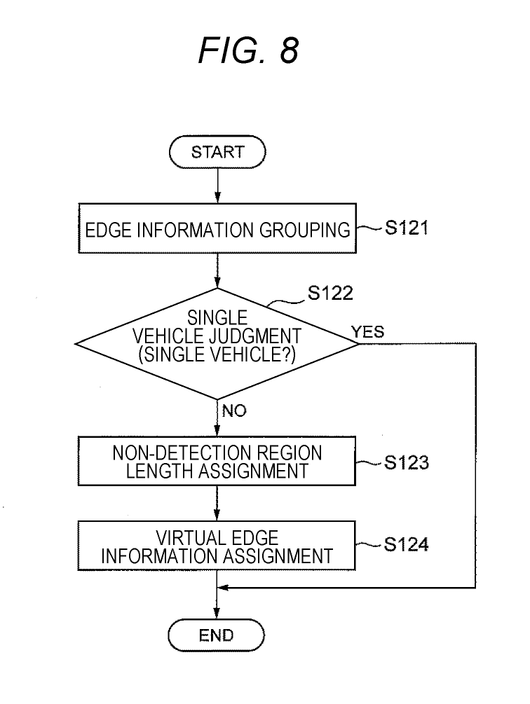

A process relating to such a case where a target vehicle is detected with the non-detection region sandwiched between the detection regions will be described with reference to a flowchart illustrated in FIG. 8. This process is a process relating to the entire vehicle recognition process S111 in FIG. 5 by the vehicle length determination unit 3 in the block configuration diagram of the object detection device 1 in FIG. 1 described in the above first embodiment. That is, the process of the flowchart illustrated in FIG. 8 is included in the entire vehicle recognition process S111 and all other processes follow the processes described in the above first embodiment.

In an edge information grouping process S121, based on edge information (information on the end portion) on the detected vehicle found out in the front/rear edge recognition process S102 for the detected matter in the above first embodiment, re-grouping is performed between the detected vehicles detected with the non-detection region sandwiched.

In a single vehicle judgment process S122, it is determined whether the information re-grouped in the edge information grouping process S121 represents a single vehicle.

In a case where it is determined in the single vehicle judgment process S122 that the re-grouped information represents a single vehicle, it is assumed that the entire vehicle is recognized, for example, with regard to a detected marker including the information on the front and rear edge portions (end points); then, a distance between coordinates of the front and rear edge portions (end points) is computed in the front-rear-edge-distance computation process S112 and a calculation result thereof is output as the vehicle length of the target vehicle in the vehicle length output process S113, as described in the above first embodiment.

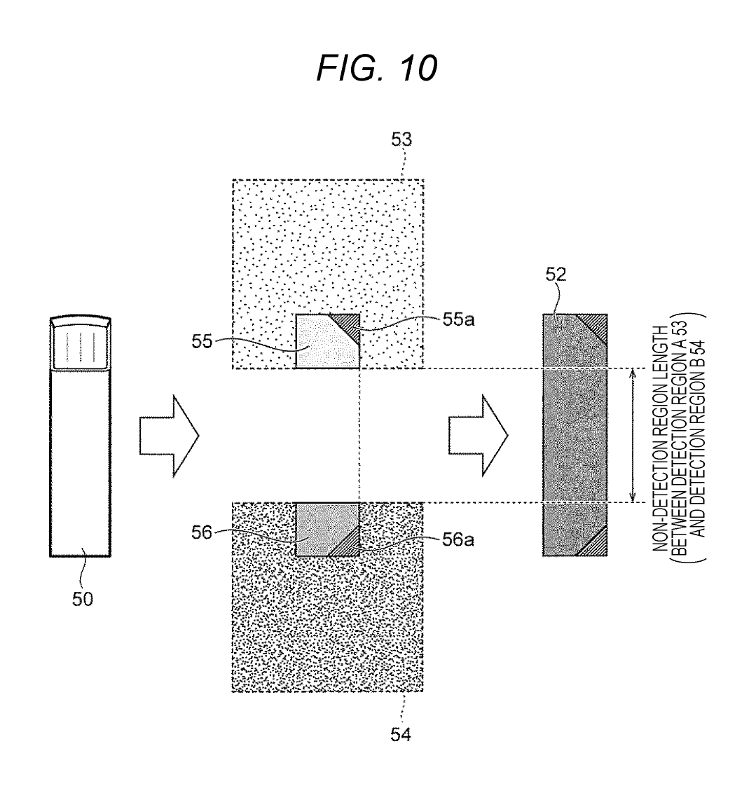

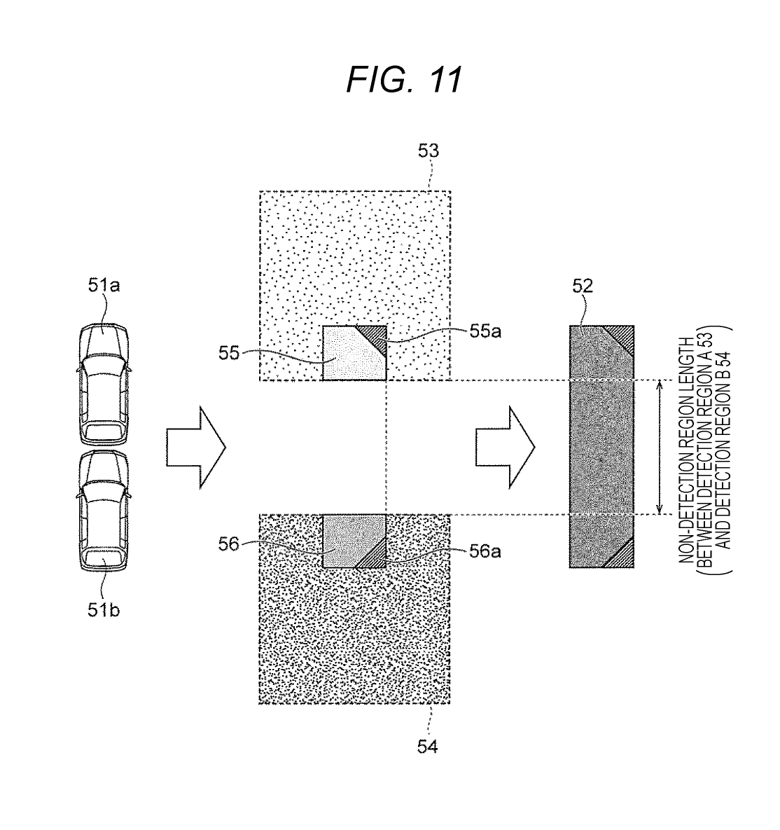

In other words, when both end portions (not necessarily both end portions of the same object) of the detected marker are detected across a plurality of detection regions with a non-detection region sandwiched therebetween, a region obtained by coupling (grouping) the object presence regions in the respective detection regions in which the end portions are detected and the non-detection region present therebetween is specified or estimated as an object presence region and a length of this object presence region in a predetermined direction (for example, a direction joining both the end portions, the front-rear direction of the vehicle, or a moving direction of the detected object) is determined as the vehicle length of the target vehicle (detailed later on the basis of specific examples in FIGS. 10 and 11).

On the other hand, when it is determined in the single vehicle judgment process S122 that the re-grouped information does not represent a single vehicle, with regard to a detected marker having, for example, information on only one of the front or rear edge portions (end points) and a condition insufficient to be regarded as one vehicle, a non-detection region length of the non-detection region is added to the detection information (object presence region) on the detection region in a non-detection region length assignment process S123, presuming that the target (vehicle) is present across the non-detection region. That is, when the target is present across the non-detection region, it is presumed that the target is present in the entire non-detection region.

Next, by adding virtual edge (end portion) information for the added portion in a virtual edge information assignment process S124 in consideration of the non-detection region length added in the non-detection region length assignment process S123, it is assumed that the entire vehicle is recognized; then, a distance between coordinates of the front and rear edge portions (end points) is computed in the front-rear-edge-distance computation process S112 and a calculation result thereof is output as the vehicle length of the target vehicle in the vehicle length output process S113, as described in the above embodiment.

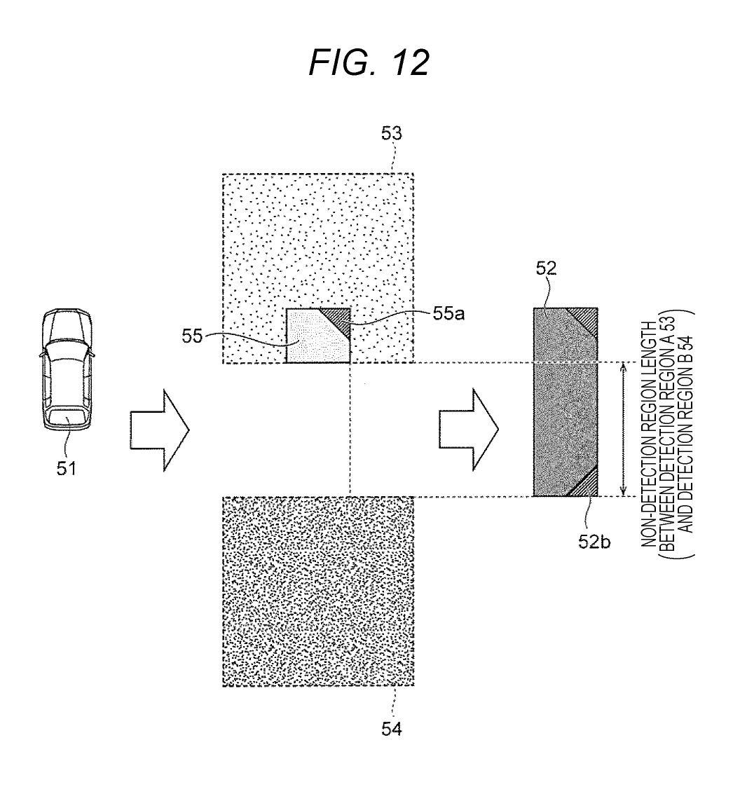

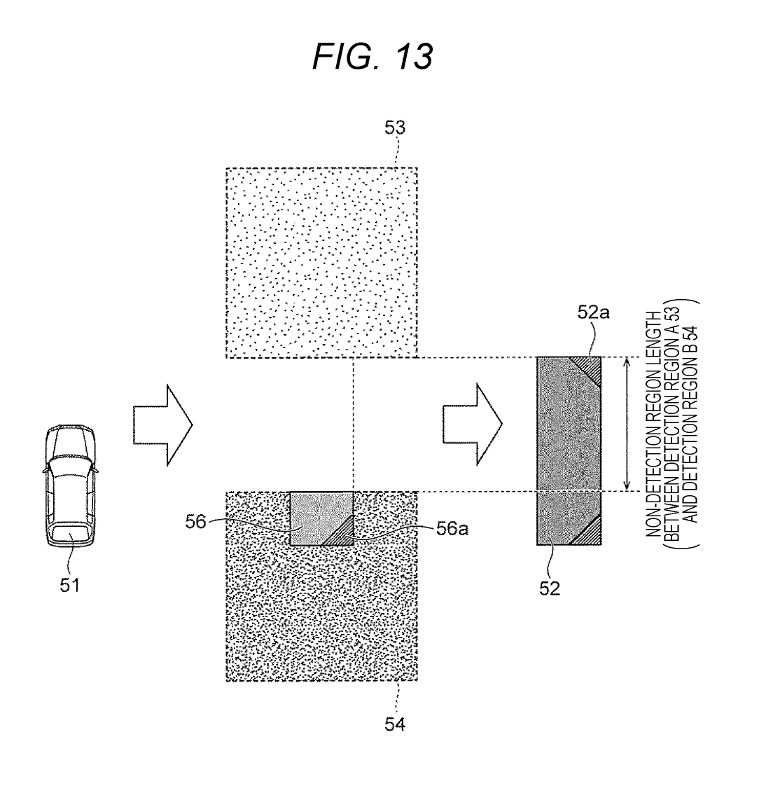

In other words, when one end portion of an object (detected marker) is detected in the detection region and the other end portion of the object (detected marker) is not detected in the detection region, a region obtained by coupling (grouping) the object presence region in the detection region in which this one end portion is detected and a non-detection region (entire range in a predetermined direction) adjacent to this object presence region is specified or estimated as an object presence region and a length of this object presence region in a predetermined direction (for example, a direction joining both the end portions, the front-rear direction of the vehicle, or a moving direction of the detected object) is determined as the vehicle length of the target vehicle (detailed later on the basis of specific examples in FIGS. 12 and 13).

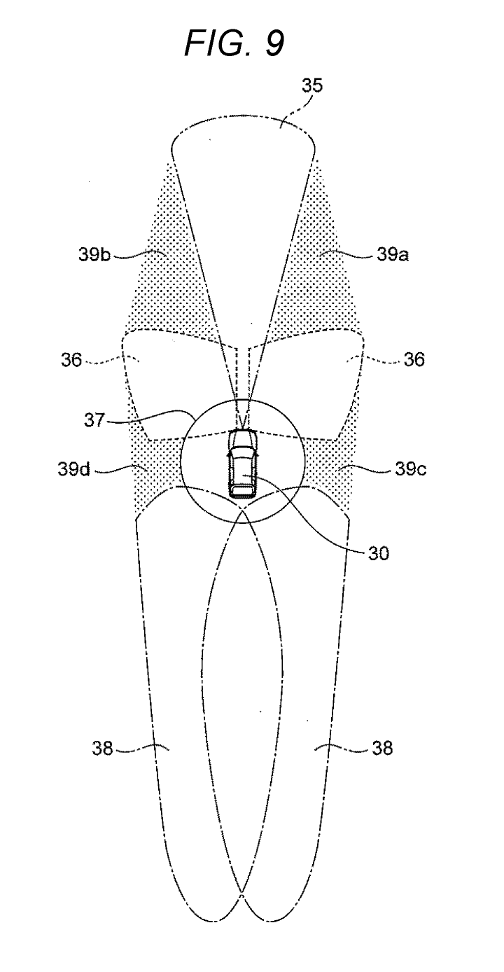

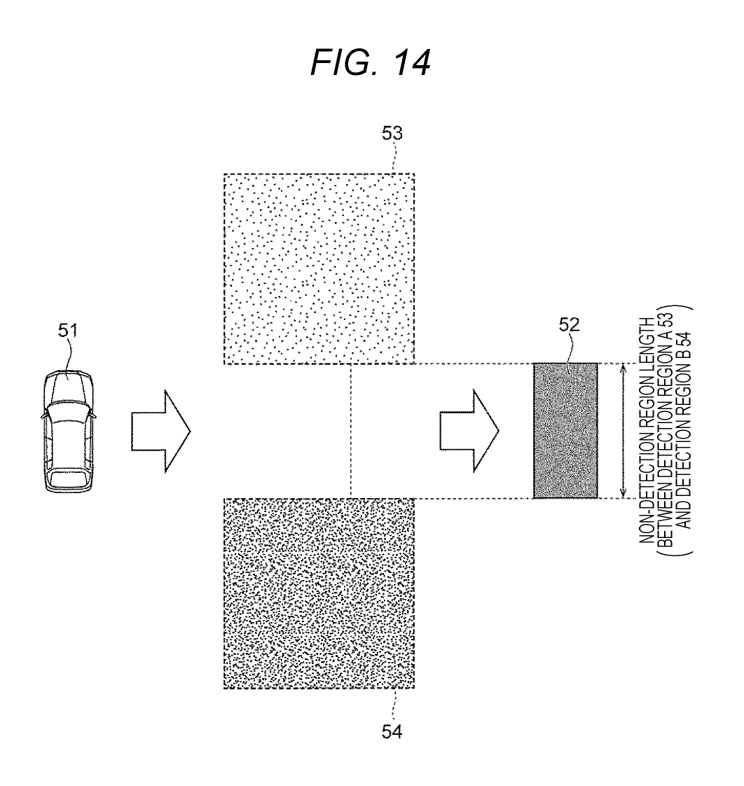

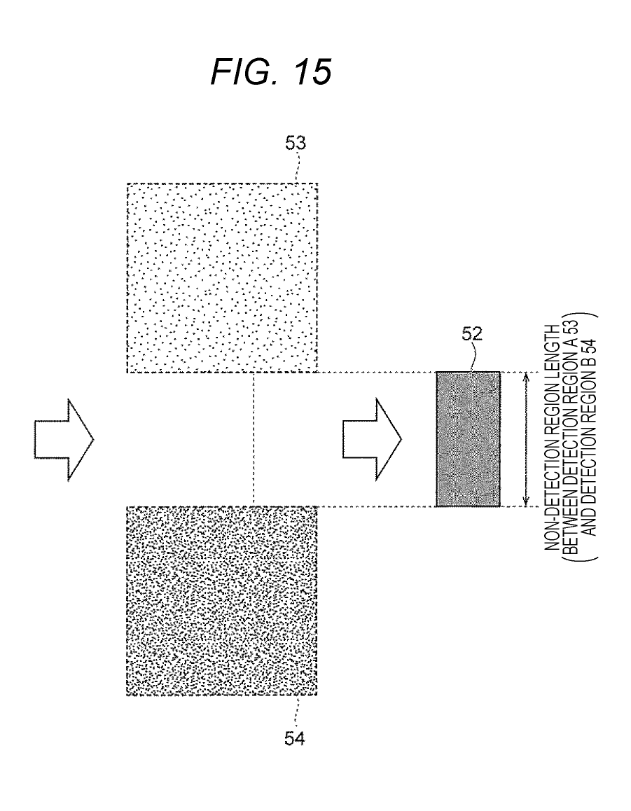

That is, in the present embodiment, in the entire vehicle recognition process S111 in the vehicle length determination unit 3, the non-detection region in which an object cannot be detected by a sensor or the like mounted on the vehicle 30, such as an area between the respective detection regions in the periphery of the vehicle 30 and a predetermined range from the vehicle 30 on the outside of the respective detection regions, is settled in advance as an object presence possibility region (39a to 39d) in which an object may be present (refer to FIG. 9). Then, when a part of an object (target vehicle) is detected in a certain detection region, a region obtained by coupling (grouping) an object presence region obtained by finding out the object in this detection region and a region of the object presence possibility region adjacent to this object presence region in this detection region is specified or estimated as an object presence region in which an object is present or an object may be present (detailed later on the basis of specific example in FIGS. 12 and 13). In addition, even when an object (target vehicle) is not detected at all in any detection region, an arbitrary region of the object presence possibility region (for example, a region having a predetermined length (a general vehicle length or longer) in the front-rear direction on the side of the vehicle) is estimated for the vehicle in advance as an object presence region in which an object may be present (detailed later on the basis of the specific examples in FIGS. 14 and 15).

<Processing Pattern of Target Vehicle Detection (1)>

FIGS. 10 and 11 conceptually illustrate processing patterns in the case of detecting a target vehicle with a non-detection region sandwiched between different detection regions, particularly, processing patterns in the case of detecting a target vehicle (not necessarily the same vehicle) in each of the different detection regions.

FIG. 10 illustrates the same situation as that in FIG. 6.

When different detection region A 53 and detection region B 54 are disposed (with a non-detection region sandwiched therebetween) and a part of a target vehicle 50 is detected in each detection region, a part of the target vehicle 50 is detected as a detected marker (an object presence region in the detection region A 53) 55 in the detection region A 53. Likewise, a part of the target vehicle 50 is detected as a detected marker (an object presence region in the detection region B 54) 56 in the detection region B 54. The edge information on the detected markers 55 and 56 are noted as 55a and 56a, respectively. Here, presuming that a part of the target vehicle 50 is present also in the non-detection region (=object presence possibility region) sandwiched between the detected marker 55 and the detected marker 56, the process is carried out by recognizing a region obtained by adding a non-detection region length of the non-detection region to the detected marker 55 and the detected marker 56 as a detected vehicle (=object presence region) 52.

In addition, in this case, it is also conceivable that, as illustrated in FIG. 11, a plurality of (two in the illustrated example) target vehicles 51a and 51b aligned in series (longitudinally) are detected with a non-detection region sandwiched between different detection regions.

In the detection region A 53, a part (front part) of the target vehicle 51a on the front side is detected. In the detection region B 54, a part (rear part) of the target vehicle 51b on the rear side is detected. At this point, the detected marker 55 in the detection region A 53 and the detected marker 56 in the detection region B 54 are equivalent to the pattern in FIG. 10 and it is not possible to distinguish the plurality of (two) target vehicles 51a and 51b in reality. Therefore, similarly to the pattern in FIG. 10, presuming that the target vehicles 51a and 51b are present as the same object also in the non-detection region (=object presence possibility region) sandwiched between the detected marker 55 and the detected marker 56, the process is carried out by recognizing a region obtained by adding a non-detection region length of the non-detection region to the detected marker 55 and the detected marker 56 as the detected vehicle (=object presence region) 52.

<Processing Pattern of Target Vehicle Detection (2)>

FIGS. 12 and 13 conceptually illustrate processing patterns in the case of detecting a target vehicle with a non-detection region sandwiched between different detection regions, particularly, processing patterns in the case of detecting a target vehicle in only one detection region.

In the example illustrated in FIG. 12, a part (front part) of a target vehicle 51 is detected only in the detection region A 53. In the detection region B 54, a detected matter is not present (not detected) and it can be inferred that the rear edge portion (end point) of the target vehicle 51 is located within a non-detection region (=object presence possibility region) between the detection region A 53 and the detection region B 54.

However, it is not possible to further distinguish which range of this non-detection region is concerned. Therefore, the process is carried out by adding the non-detection region length of the non-detection region adjacent to the detected marker 55 in the detection region A 53 to the detected marker 55 in the detection region A 53 to recognize as the detected vehicle (=object presence region) and at the same time by recognizing virtual edge information 52b at this detected vehicle 52 (a portion of the non-detection region length thereof).

Likewise, in the example illustrated in FIG. 13, a part (rear part) of the target vehicle 51 is detected only in the detection region B 54. In the detection region A 53, a detected matter is not present (not detected) and it can be inferred that the front edge portion (end point) of the target vehicle 51 is located within a non-detection region (=object presence possibility region) between the detection region A 53 and the detection region B 54. However, it is not possible to further distinguish which range of this non-detection region is concerned. Therefore, the process is carried out by adding the non-detection region length of the non-detection region adjacent to the detected marker 56 in the detection region B 54 to the detected marker 56 in the detection region B 54 to recognize as the detected vehicle (=object presence region) and at the same time by recognizing virtual edge information 52a at this detected vehicle 52 (a portion of the non-detection region length thereof).

<Processing Pattern of Target Vehicle Detection (3)>

FIGS. 14 and 15 conceptually illustrate processing patterns in the case of detecting a target vehicle with a non-detection region sandwiched between different detection regions, particularly, processing patterns in a case where no detected marker (object presence region) is present in adjacent detection regions (detection regions neighboring to each other) sandwiching an undetected region therebetween (in different terms, no detected matter is present in any detection region).

In the example illustrated in FIG. 14, the target vehicle 51 is present only in the non-detection region (=object presence possibility region) in the periphery of the vehicle. In this case, a detected marker is present in neither the detection region A 53 nor the detection region B 54 and the target vehicle 51 is still not detected in any detection region. This situation is equivalent to the state illustrated in FIG. 15 in which no target vehicle is present in the periphery of the vehicle. Therefore, in the situations illustrated in FIGS. 14 and 15, presuming that a target vehicle is always present within the non-detection region (in particular, within a range of the non-detection region decided in advance for the vehicle), the process is carried out by recognizing a whole non-detection region length of the non-detection region sandwiched by the detection regions as the detected vehicle (=object presence region) 52. However, the non-detection region length (the detected vehicle 52) in this case is settled to be equal to or longer than a general vehicle length.

As described thus far, according to the object detection device 1 of the present second embodiment, by associating detection results from the external environment information acquisition unit 2 for different detection regions in the surroundings of the vehicle, it is possible to appropriately specify or estimate an object presence region in which an object such as another vehicle in the periphery of the vehicle is present and appropriately calculate the vehicle length and the like of the another vehicle.

[Vehicle Control System]

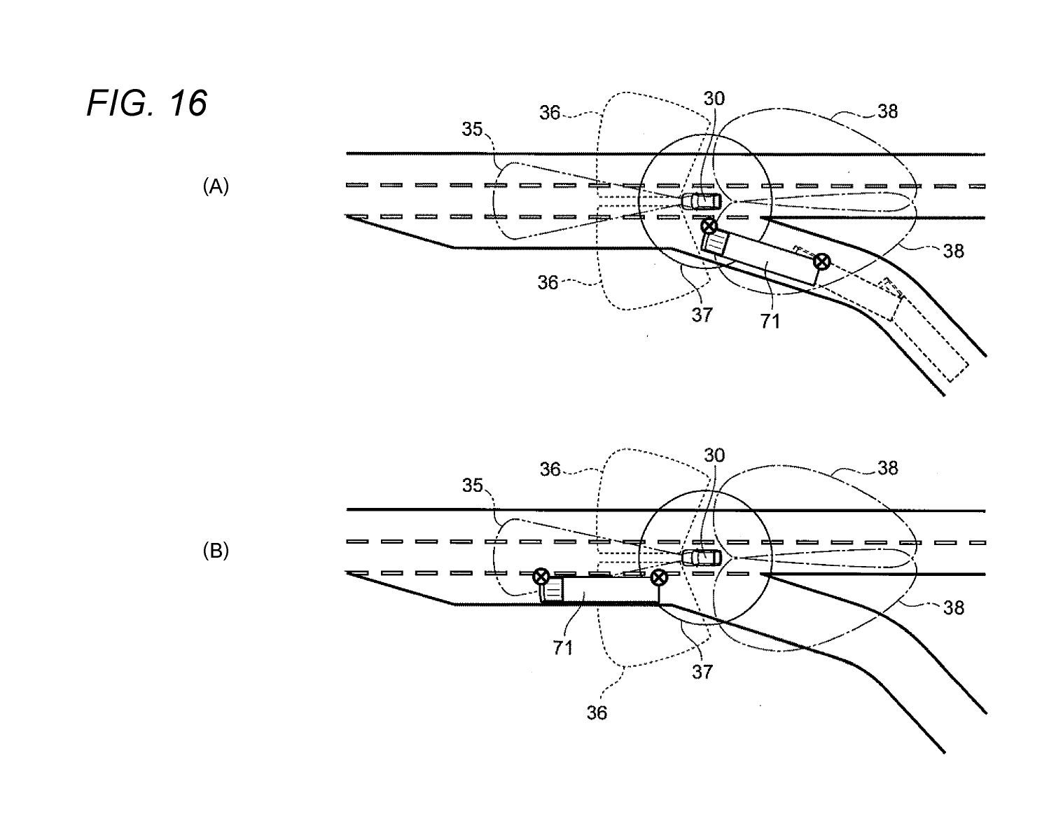

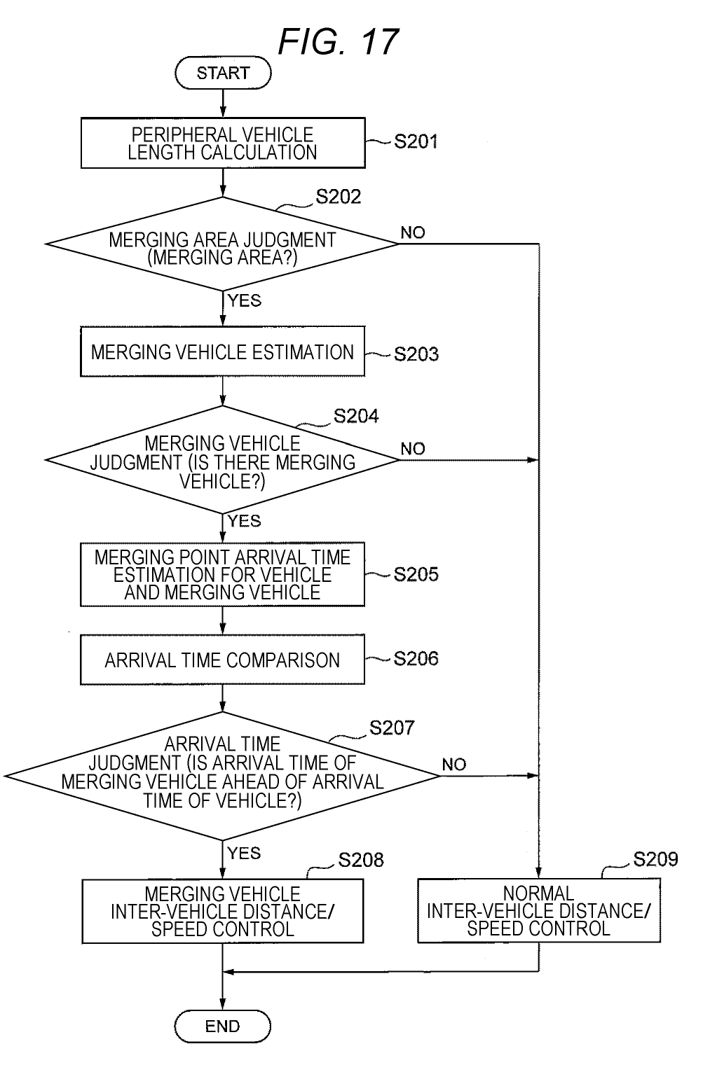

Next, one embodiment of a vehicle control system according to the present invention using one of the above-described object detection devices will be outlined with reference to FIGS. 16 and 17.

As illustrated in FIGS. 16(A) and 16(B), a situation is supposed here in which, when the vehicle 30 is traveling on a main line and a merging vehicle 71 is merging to the main line from a merging lane at a merging section in the front, a traveling state of the vehicle 30 is controlled (inter-vehicle distance control) by the travel control device. However, for example, it goes without saying that the present invention can be similarly applied to a case where the vehicle merges to the main line from the merging lane.

Note that, in the description of the object detection device according to the second embodiment described above, it is presumed that a target vehicle is present in advance in the non-detection region in which an object cannot be detected by a sensor of the external environment information acquisition unit 2 mounted on the vehicle 30. However, in a merging scene as illustrated in FIGS. 16(A) and 16(B), such an object (target vehicle) is defined to have both the same bearing and speed as those of the vehicle 30 but solely have a different presence position therefrom and is not regarded as a merging vehicle.

In other words, in a merging scene as illustrated in FIGS. 16(A) and 16(B), if the object (target vehicle) presumed to be present in the non-detection region at a certain time is different from the vehicle 30 in speed and bearing, the object after a predetermined time (Δt) will move into the detection region or outside the detection region. In this case, if the object has moved into the detection region, the above-described process of the object detection device of the second embodiment is applied. Otherwise the object is regarded as having moved outside the detection region and will not be regarded as a merging vehicle in a pattern other than the pattern of moving into the detection region.

FIG. 17 illustrates a processing flow of travel control (inter-vehicle distance control) by the vehicle control system according to the present invention.

In a peripheral vehicle length calculation process S201, the vehicle length of a vehicle detected by a sensor of the external environment information acquisition unit 2 mounted on the vehicle is constantly (periodically) calculated using the above-described object detection device.

In a merging area judgment process S202, it is judged from, for example, map information and front camera information whether there is a merging area in front of the vehicle.

When it is judged in the merging area judgment process S202 that there is a merging area, in a merging vehicle estimation process S203, whether a peripheral vehicle recognized in the peripheral vehicle length calculation process S201 is a merging vehicle in this merging area is estimated from the behavior (bearing, acceleration, traveling history, and the like) of this peripheral vehicle.

In a merging vehicle judgment process S204, whether there is a merging vehicle is judged from an estimation result in the merging vehicle estimation process S203.

When it is judged in the merging vehicle judgment process S204 that there is a merging vehicle, in a merging point arrival time estimation process S205 for the vehicle and the merging vehicle, the arrival times to the merging point of both of the vehicle and the merging vehicle are estimated from the traveling state and the like of the vehicle and the merging vehicle.

In an arrival time comparison process S206, the arrival times to the merging point estimated in the merging point arrival time estimation process S205 for the vehicle and the merging vehicle are compared between the vehicle and the merging vehicle.

In an arrival time judgment process S207, it is judged which one of the arrival times to the merging point compared in the arrival time comparison process S206 is earlier, in detail, whether the arrival time to the merging point of the merging vehicle is ahead of that of the vehicle.

When it is judged in the arrival time judgment process S207 that the merging vehicle has an earlier arrival time to the merging point, in a merging vehicle inter-vehicle distance/speed control process S208, inter-vehicle distance control and speed control with respect to the merging vehicle is performed according to the behavior, the vehicle length, and the like of the merging vehicle by the travel control device mounted on the vehicle so as to guide the vehicle behind or in front of the merging vehicle (in other words, the object presence region derived by the object detection device) in the moving direction.

On the other hand, when it is judged in the merging area judgment process S202 that there is no merging area, or it is judged in the merging vehicle judgment process S204 that there is no merging vehicle, or it is judged in the arrival time judgment process S207 that the vehicle first arrives at the merging point, normal vehicle travel control is performed in a normal inter-vehicle distance/speed control process S209.

Note that, in the above embodiment, the normal vehicle travel control is performed when it is judged in the arrival time judgment process S207 that the vehicle first arrives at the merging point. However, for example, even when it is judged that the vehicle first arrives at the merging point in the arrival time judgment process S207 from the arrival times to the merging point and behavior of the vehicle and the merging vehicle, traffic and road environments in the periphery of the vehicle, and the like, speed control and the like of this vehicle may be performed in order to support smooth merging.

As described thus far, according to the vehicle control system of the present embodiment, by controlling the traveling state of the vehicle based on the object presence region (for example, vehicle length information on another vehicle) specified or estimated by the object detection device, for example, determination on vehicle interrupting (being interrupted) at the time of merging during operation of the automatic driving/driving support system can be accurately judged.

The invention is not construed to be limited to the aforementioned embodiments and includes various types of variations. For example, the aforementioned embodiments have been described in detail in order to make the description of the invention easy to understand. Therefore, the embodiments are not necessarily limited to the ones provided with the whole configurations that have been described. In addition, part of the configuration of a certain embodiment can be replaced with the configuration of another embodiment, while it is also possible to add the configuration of a certain embodiment to the configuration of another embodiment. Part of the configuration of each of the embodiments can be subjected to addition, deletion, and replacement of another configuration.

Furthermore, part or all of the respective configurations, functions, processing units, processing means, and the like described above may be implemented by hardware designed, for example, using an integrated circuit. The respective configurations, functions, and the like described above may be implemented by software in which a processor parses a program that implements each of the functions to execute. Information such as the programs, the tables, and the files that implement the respective functions can be placed on a storage device including a memory, a hard disk, and a solid state drive (SSD), or alternatively, a recording medium including an integrated circuit (IC) card, an SD card, and a digital versatile disc (DVD).

Meanwhile, the control lines and the information lines considered to be necessary for the description are indicated and therefore, all of the control lines and the information lines on a product are not necessarily indicated. Actually, substantially all of the configurations may be considered to be connected to each other.

### REFERENCE SIGNS LIST

1 object detection device
2 external environment information acquisition unit
3 vehicle length determination unit (object presence region setting unit)
7 physical value computation unit
8 fusion computation unit
9 vehicle length computation unit
30 vehicle
31 target vehicle
32 detected matter
33 detected matter
34 target vehicle grouped as same vehicle
35 front camera detection region
36 front side radio wave radar detection region
37 360-degree wide angle camera detection region
38 rear side radio wave radar detection region
39a to 39d object presence possibility region
50 target vehicle
51 target vehicle
51a target vehicle
51b target vehicle
52 estimated detected vehicle (object presence region)
53 detection region A
54 detection region B
55 detected matter (detected marker) in detection region A
56 detected matter (detected marker) in detection region B
71 merging vehicle

1. An object detection device comprising:
an external environment information acquisition unit that acquires external environment information for different detection regions in the surroundings of a vehicle; and
an object presence region setting unit that associates detection results from the external environment information acquisition unit for the different detection regions and specifies, or estimates, object presence regions in which an object is present or in which an object may be present in the surroundings of the vehicle.

2. The object detection device according to claim 1, wherein the object presence region setting unit changes a specification or estimation method for the object presence regions on the basis of whether the object has been detected in each detection region.

3. The object detection device according to claim 1, wherein, when detecting the object in at least one of the detection regions, the object presence region setting unit specifies or estimates a region of the one of the detection regions including the object as one of the object presence regions.

4. The object detection device according to claim 3, wherein, when the entire object is detected across a plurality of detection regions, the object presence region setting unit specifies or estimates a region obtained by grouping object presence regions in respective detection regions of the plurality of detection regions as one of the object presence regions.

5. The object detection device according to claim 3, wherein, when one or a plurality of end portions of the object is detected across a plurality of detection regions with a non-detection region sandwiched therebetween, the object presence region setting unit specifies or estimates a region obtained by grouping object presence regions in the respective detection regions in which the end portions have been detected, and the non-detection region present therebetween, as one of the object presence regions.

6. The object detection device according to claim 3, wherein, when one end portion of the object is detected in one of the detection regions and another end portion of the object is not detected in the detection regions, the object presence region setting unit specifies or estimates a region obtained by grouping an object presence region in the one of the detection regions in which the one end portion has been detected, and a non-detection region adjacent to this object presence region, as one of the object presence regions.

7. The object detection device according to claim 3, wherein the object presence region setting unit determines a length of one of the object presence regions in a predetermined direction as a length of another vehicle in the surroundings of the vehicle.

8. The object detection device according to claim 3, wherein the object presence region setting unit calculates a length of another vehicle in the surroundings of the vehicle from end portion information on the object presence regions.

9. The object detection device according to claim 1, wherein, when a non-detection region is present between detection regions neighboring to each other, the object presence region setting unit sets the non-detection region as one of the object presence regions in which the object may be present.

10. The object detection device according to claim 9, wherein the object presence region setting unit determines a length of one of the object presence regions in a predetermined direction as a length of another vehicle in the surroundings of the vehicle.

11. The object detection device according to claim 9, wherein the object presence region setting unit calculates a length of another vehicle in the surroundings of the vehicle from end portion information on the object presence regions.

12. A vehicle control system comprising:
the object detection device according to claim 1; and
a travel control device that controls a traveling state of the vehicle on the basis of an object presence region specified or estimated by the object detection device.

13. The vehicle control system according to claim 12, wherein the travel control device controls a traveling state of the vehicle so as to guide the vehicle in front of or behind the object presence region while the vehicle is traveling.

14. An object detection device comprising:
an external environment information acquisition unit that acquires external environment information for different detection regions in the surroundings of a vehicle; and
a vehicle length determination unit that associates detection results from the external environment information acquisition unit for the different detection regions and determines a length of another vehicle detected in the surroundings of the vehicle.
